(19) United States
(12) Patent Application Publication
(10) Pub. No.: US 2024/0198632 A1
(43) Pub. Date: Jun. 20, 2024

(54) DISPLAY DEVICE AND METHOD OF MANUFACTURING THE SAME

(71) Applicant: TPK Auto Tech (Xiamen) Limited, Xiamen (CN)

(72) Inventors: Shih Hao CHEN, Hsinchu County (TW); Yun Chine LO, Taipei City (TW); Yung Feng YEH, Tainan City (TW); Tao LU, Xiamen City (CN); Shui Ying LIN, Zhangzhou City (CN)

(21) Appl. No.: 18/084,597

(22) Filed: Dec. 20, 2022

(51) Int. Cl. B32B 7/12; B32B 5/02; B32B 27/08; B32B 27/30; B32B 27/36; B32B 27/40

(52) U.S. Cl. CPC B32B 7/12; B32B 5/02; B32B 27/08; B32B 27/308; B32B 27/36; B32B 27/40; B32B 2307/51; B32B 2457/20

(57) ABSTRACT

A display device includes a protection assembly and an outer frame. The protection assembly includes a cover plate and an elastic structure. The elastic structure includes a first adhesive layer, a second adhesive layer, and an elastic layer. The first adhesive layer is adhered to the cover plate. The elastic layer is disposed between the first adhesive layer and the second adhesive layer. The outer frame is adhered to the second adhesive layer. A modulus of elasticity of the elastic structure is between 120 N/compression % and 200 N/compression %. A peel adhesive force between the second adhesive layer and the outer frame is between 8 N/25 mm and 100 N/25 mm.

### BACKGROUND

### Technical Field

The present disclosure relates to a display device.

### Description of Related Art

At present, the bonding of electronic components is mostly a dispensing method using a heat-curing liquid adhesive. However, the traditional dispensing method has at least the following problems: (1) the gap is uneven, and the glue easily overflows after coating, which affects the appearance and touch feeling; (2) it is not easy to dispense glue (easy to lack glue) in the small gap, and the cover plate and the housing are prone to split cracks during the thermal shock test and high temperature and high humidity test; and (3) the manufacturing process needs to add dispensing and curing equipment, and the production time is long.

Accordingly, how to provide a display device and a method of manufacturing the same to solve the aforementioned problems becomes an important issue to be solved by those in the industry.

### SUMMARY

An aspect of the disclosure is to provide a display device and method of manufacturing the same that can efficiently solve the aforementioned problems.

According to an embodiment of the disclosure, a display device includes a protection assembly and an outer frame. The protection assembly includes a cover plate and an elastic structure. The elastic structure includes a first adhesive layer, a second adhesive layer, and an elastic layer. The first adhesive layer is adhered to the cover plate. The elastic layer is disposed between the first adhesive layer and the second adhesive layer. The outer frame is adhered to the second adhesive layer. A modulus of elasticity of the elastic structure is between 120 N/compression % and 200 N/compression %. A peel adhesive force between the second adhesive layer and the outer frame is between 8 N/25 mm and 100 N/25 mm.

In an embodiment of the disclosure, a viscosity of the second adhesive layer is greater than a viscosity of the first adhesive layer.

In an embodiment of the disclosure, a thickness of the elastic structure is in a range from 0.55 mm to 1.05 mm.

In an embodiment of the disclosure, a material of the first adhesive layer includes a polymer.

In an embodiment of the disclosure, a material of the elastic layer includes polyurethane.

In an embodiment of the disclosure, a material of the second adhesive layer includes acrylic fiber.

In an embodiment of the disclosure, the material of the second adhesive layer further includes polyethylene terephthalate.

In an embodiment of the disclosure, the elastic structure is frame-shaped.

In an embodiment of the disclosure, the display device further includes a display module. The display module is disposed between the cover plate and the outer frame. The elastic structure surrounds the display module.

In an embodiment of the disclosure, the display module and the outer frame are fastened to each other.

In an embodiment of the disclosure, a surface of the outer frame bonded to the second adhesive layer is uneven. A gap difference between the outer frame and the cover plate is less than 0.3 mm. The gap difference is less than 1.2 mm after the elastic structure is removed.

According to an embodiment of the disclosure, a method of manufacturing a display device includes: providing an elastic structure, in which the elastic structure includes a first adhesive layer, a second adhesive layer, and an elastic layer, the elastic layer is disposed between the first adhesive layer and the second adhesive layer, and a modulus of elasticity of the elastic structure is between 120 N/compression % and 200 N/compression %; adhering the first adhesive layer and a cover plate, such that the cover plate and the elastic structure form a protection assembly; and adhering the second adhesive layer and an outer frame, in which a peel adhesive force between the second adhesive layer and the outer frame is between 8 N/25 mm and 100 N/25 mm.

In an embodiment of the disclosure, a viscosity of the second adhesive layer is greater than a viscosity of the first adhesive layer.

In an embodiment of the disclosure, a material of the first adhesive layer includes a polymer.

In an embodiment of the disclosure, a material of the elastic layer includes polyurethane.

In an embodiment of the disclosure, a material of the second adhesive layer includes acrylic fiber.

In an embodiment of the disclosure, the material of the second adhesive layer further includes polyethylene terephthalate.

In an embodiment of the disclosure, the method further includes: performing a plasma cleaning process to the cover plate before adhering the first adhesive layer and the cover plate.

In an embodiment of the disclosure, the method further includes: performing a plasma cleaning process to the outer frame before adhering the second adhesive layer and the outer frame.

Accordingly, in the display device of the present disclosure, the cover plate of the protection assembly is bonded to the outer frame through the elastic structure. Specifically, the elastic structure is a composite structure composed of multiple adhesive layers and an elastic layer, so the elastic structure can significantly reduce the gap difference between the cover plate and the outer frame, thereby improving the flatness. Moreover, compared with the traditional glue dispensing method, the method of manufacturing a display device of the present disclosure has the effects of process savings and yield improvement.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a cross-sectional view of a display device according to an embodiment of the present disclosure;

FIG. 2 is a cross-sectional view of an elastic structure according to an embodiment of the present disclosure;

FIG. 3 is a compression test curve chart of elastic structures according to various examples of the present disclosure;

FIG. 4 is a schematic diagram illustrating a peel test performed on an elastic structure according to an embodiment of the present disclosure;

FIG. 5 is a cross-sectional view of a display device according to another embodiment of the present disclosure;

FIG. 6 is a top view of the display device; and

FIG. 7 is a flowchart of a method of manufacturing a display device according to an embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. However, specific structural and functional details disclosed herein are merely representative for purposes of describing example embodiments, and thus may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the disclosure.

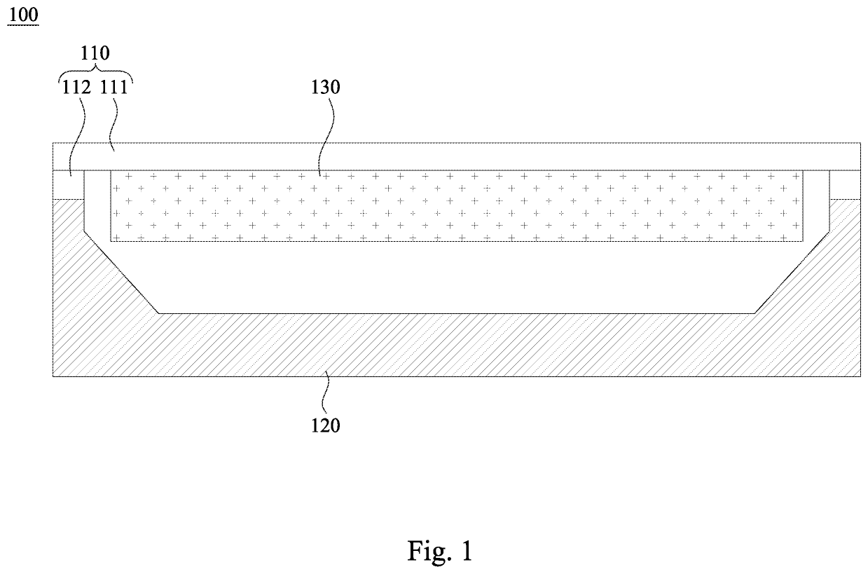

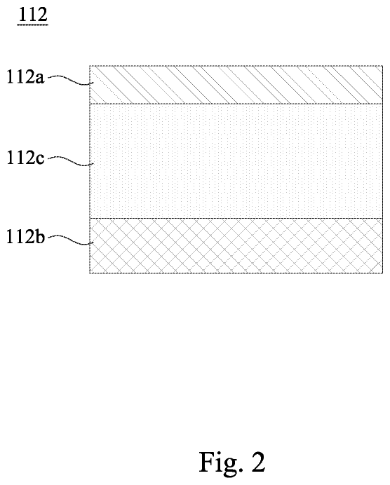

Reference is made to FIGS. 1 and 2. FIG. 1 is a cross-sectional view of a display device 100 according to an embodiment of the present disclosure. FIG. 2 is a cross-sectional view of an elastic structure 112 according to an embodiment of the present disclosure. As shown in FIGS. 1 and 2, in the present embodiment, the display device 100 includes a protection assembly 110, an outer frame 120, and a display module 130. The protection assembly 110 includes a cover plate 111 and an elastic structure 112. The elastic structure 112 includes a first adhesive layer 112a, a second adhesive layer 112b, and an elastic layer 112c. The first adhesive layer 112a is adhered to the cover plate 111. The elastic layer 112c is disposed between the first adhesive layer 112a and the second adhesive layer 112b. The outer frame 120 is adhered to the second adhesive layer 112b. A modulus of elasticity of the elastic structure 112 is between 120 N/compression % and 200 N/compression %.

It should be noted here that the modulus of elasticity in the present disclosure is defined as the ratio of the normal force (N; Newton) and the normal compression ratio (%) that the elastic structure 112 bears when the deformation does not exceed the elastic limit of the material. A peel adhesive force between the second adhesive layer 112b and the outer frame 120 is between 8 N/25 mm and 100 N/25 mm. The display module 130 is disposed between the cover plate 111 and the outer frame 120. The elastic structure 112 is located on a side of the display module 130.

It should be noted that if the elastic structure 112 is softer, the gap between the cover plate 111 and the outer frame 120 is more controllable. On the contrary, if the elastic structure 112 is harder, the gap between the cover plate 111 and the outer frame 120 is more uncontrollable. Therefore, after repeated experiments, the applicant found that if the modulus of elasticity of the elastic structure 112 is less than 120 N/compression %, the elastic structure 112 will be too soft to provide sufficient support for the cover plate 111; and if the modulus of elasticity of the elastic structure 112 is greater than 200 N/compression %, the elastic structure 112 will be too hard, and the selection of materials that can meet the aforementioned peel adhesive force will be severely limited.

In addition, if the peel adhesive force between the second adhesive layer 112b and the outer frame 120 is less than 8 N/25 mm, the tension of the elastic structure 112 is not enough to regulate the gap between the cover plate 111 and the outer frame 120; and if the peel adhesive force between the second adhesive layer 112b and the outer frame 120 is greater than 100 N/25 mm, the selection of materials for the elastic structure 112 will be severely limited.

In some embodiments, a material of the cover plate 111 includes glass and plastics, but the present disclosure is not limited in this regard. In some embodiments, the plastics include polyether ether ketone (PEEK), polyimide (Polyimide, PI), polyethylene terephthalate (PET), polycarbonate (PC), polyethylene succinate (PES), polymethyl methacrylate (PMMA), polyester film (Mylar), or any combination of at least two of them, but the present disclosure is not limited in this regard.

In some embodiments, a thickness of the elastic structure is in a range from 0.55 mm to 1.05 mm, such as 0.8 mm, but the present disclosure is not limited in this regard. It should be noted that, if the thickness of the elastic structure 112 is less than 0.55 mm, the fit between the protection assembly 110 and the outer frame 120 cannot be matched. If the thickness of the elastic structure 112 is greater than 1.05 mm, it is not conducive to thinning the display device 100. In some embodiments, the thickness of the first adhesive layer 112a is 0.1 mm, the thickness of the elastic layer 112c is 0.4 mm, and the thickness of the second adhesive layer 112b is 0.05 mm, but the present disclosure is not limited in this regard. In some embodiments, the thickness of the first adhesive layer 112a is 0.3 mm, the thickness of the elastic layer 112c is 0.6 mm, and the thickness of the second adhesive layer 112b is 0.15 mm, but the present disclosure is not limited in this regard. In some embodiments, the thickness of the first adhesive layer 112a is 0.2 mm, the thickness of the elastic layer 112c is 0.5 mm, and the thickness of the second adhesive layer 112b is 0.1 mm, but the present disclosure is not limited in this regard.

In some embodiments, the elastic structure 112 is frame-shaped and surrounds the display module 130, but the present disclosure is not limited in this regard. In practical applications, the display device 100 may include a plurality of elastic structures 112, and the elastic structures 112 are sequentially arranged in a circle along the edge of the cover plate 111 and surround the display module 130 together.

In some embodiments, a material of the first adhesive layer 112a includes a polymer. For example, the first adhesive layer 112a may be the bonding film of model 8620 of 3M® Company, but the present disclosure is not limited in this regard.

In some embodiments, a material of the elastic layer 112c includes polyurethane. For example, the material of the elastic layer 112c may be the foam of model poron H-48 of Nissho®, but the present disclosure is not limited in this regard.

In some embodiments, a material of the second adhesive layer 112b includes acrylic fiber. In some embodiments, the material of the second adhesive layer 112b further includes PET. For example, the second adhesive layer 112b may be a double-sided adhesive structure with a layer of PET film sandwiched between two acrylic fiber layers, but the present disclosure is not limited in this regard.

In some embodiments, a viscosity of the second adhesive layer 112b is greater than a viscosity of the first adhesive layer 112a. In the scenario where the display device 100 is applied to a vehicle system, the vibration of the vehicle will be transmitted to the elastic layer 112c through the second adhesive layer 112b and then transmitted to the first adhesive layer 112a. The vibration of the outer frame 120 is stronger than the vibration of the cover plate 111. Therefore, the adhesive force between the second adhesive layer 112b and the outer frame 120 must be strong enough to maintain the adhesion between the two. After being elastically buffered by the elastic layer 112c and then transmitted to the first adhesive layer 112a, the vibration pulling force between the first adhesive layer 112a and the cover plate 111 has become smaller, so the first adhesive layer 112a only needs a small adhesive force. In some embodiments, the viscosity of the second adhesive layer 112b is six times that of the first adhesive layer 112a, but the present disclosure is not limited in this regard.

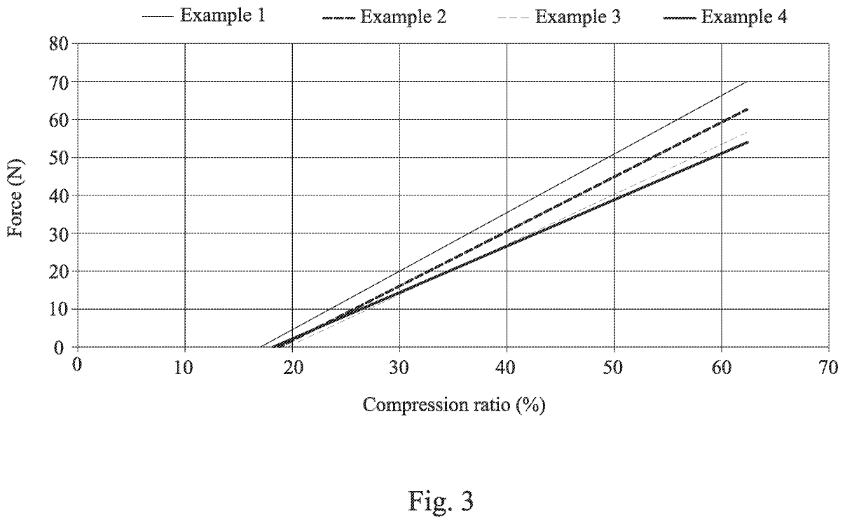

Reference is made to FIG. 3. FIG. 3 is a compression test curve chart of elastic structures 112 according to various examples of the present disclosure. It should be noted that although the same structures and materials are used in the various examples, there are still individual differences among them, which are specifically shown in the obtained actual test results. In detail, the elastic structure 112 of each example includes a three-layer structure of the first adhesive layer 112a, the second adhesive layer 112b, and the elastic layer 112c, in which the first adhesive layer 112a adopts the bonding film of model 8620 of 3M® Company, the material of the elastic layer 112c adopts the foam of model poron H-48 of Nissho®, and the second adhesive layer 112b adopts a double-sided adhesive structure with a layer of PET film sandwiched between two acrylic fiber layers. During the test, a metal indenter with a diameter of 5 mm is used to squeeze the cover plate 111 bonded to the outer frame 120 via the elastic structure 112 at a speed of 5 mm/min, and the compression characteristics of the elastic structures 112 are tested.

As shown in FIG. 3, since the elastic structures 112 bear the weight of the cover plate 111 before the metal indenter presses the cover plate 111, the elastic structure 112 in each example has a compression ratio of about 20%. Furthermore, after testing with different forces, the force-compression ratio line corresponding to the elastic structure 112 of each example can be obtained, and the slope of each line is the modulus of elasticity of the elastic structure 112 of each example. Specifically, the modulus of elasticity of the elastic structure 112 of Example 1 is about 153.72 N/compression %, the modulus of elasticity of the elastic structure 112 of Example 2 is about 144.23 N/compression %, the modulus of elasticity of the elastic structure 112 of Example 3 is about 132.01 N/compression %, and the modulus of elasticity of the elastic structure 112 of Example 4 is about 120.54 N/compression %. The moduli of elasticity of the elastic structures 112 in the Examples 1 to 4 are all in the range from 120 N/compression % to 200 N/compression %. In addition, after modifying the material of the elastic layer 112c in the elastic structure 112 from the foam of model poron H-48 of Nissho® to the material of model poron H-48, the applicant found that the modified elastic structure 112 was too soft to provide sufficient support. The modulus of elasticity of the modified elastic structure 112 is in the range from about 37.21 N/compression % to about 45.92 N/compression %. It is thus proved that the elastic structure 112 whose modulus of elasticity is lower than the lower limit value of 120 N/compression % is indeed too soft to provide sufficient support. On the other hand, materials are obviously very scarce when it comes to selecting a material with the modulus of elasticity greater than 200 N/compression % (that is, hard enough) and the peel adhesive force that meets the range from 8 N/25 mm to 100 N/25 mm (that is, enough sticky) from the existing known materials.

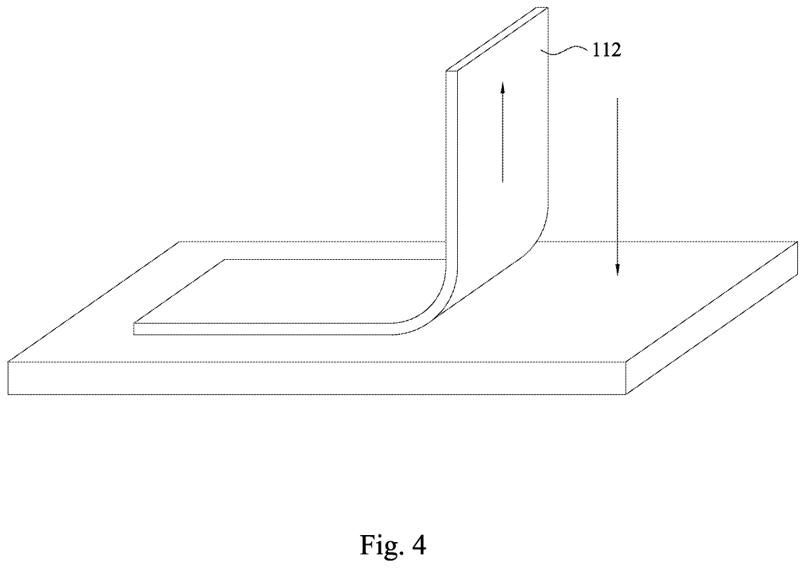

Reference is made to FIG. 4. FIG. 4 is a schematic diagram illustrating a peel test performed on the elastic structure 112 according to an embodiment of the present disclosure. It should be noted that the peel test is a 90-degree peel adhesive force test, and the test conditions are: under the standard state (23° C./50% RH), attaching the elastic structure 112 with a width of 25 mm and a length greater than 100 mm to magnesium-aluminum metal, rolling the elastic structure 112 and the magnesium-aluminum metal back and forth with a 2 kg roller (with a speed about 300 mm/min), placing the elastic structure 112 and the -aluminum metal in the standard state for 72 hours, and then peeling the elastic structure 112 off of the and the magnesium-aluminum metal at a stretching angle of 90° and a stretching speed of 300 mm/min. After several sets of experimental tests (for example, using the aforementioned Examples 1 to 4), it can be measured that the average peel adhesive force is about 8.7 N/25 mm. In addition, if the surface of the magnesium-aluminum metal is cleaned (for example, by a plasma cleaning process) before the elastic structure 112 is attached to the surface, the measured average peel adhesive can be increased to about 14.47 N/25 mm.

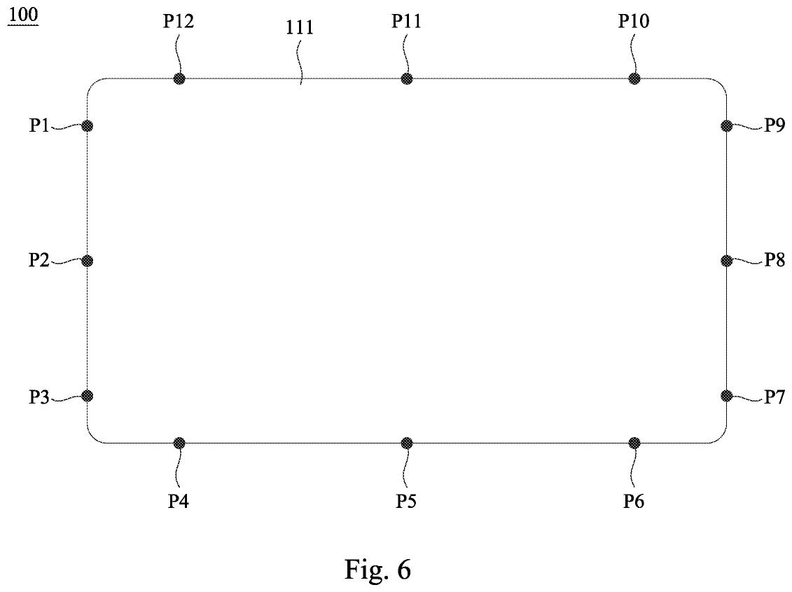

It can be seen from the foregoing configurations that the cover plate 111 of the protection assembly 110 is bonded to the outer frame 120 through the elastic structure 112. Specifically, the elastic structure 112 is a composite structure composed of multiple adhesive layers and the elastic layer 112c, so the gap difference between the cover plate 111 and the outer frame 120 can be significantly reduced, thereby improving flatness. The so-called gap difference is the difference between the maximum gap and the minimum gap at the test points between the cover plate 111 and the outer frame 120 shown in FIG. 6. In short, the elastic structure 112 of the present embodiment can be stretched at a position with a large gap and compressed at a position with a small gap, so that the flatness can be adjusted. Moreover, compared with the heat-cured liquid glue formed by the traditional dispensing method, the elastic structure 112 of the present embodiment can effectively control the gap difference between the cover plate 111 and the outer frame 120, thereby improving the flatness of the cover plate 111 relative to the outer frame 120. In addition, the heat-cured liquid glue formed by the traditional glue dispensing method often exceeds the outer edge of the cover plate 111 after solidification, for example, by 0.5 mm. On the contrary, the elastic structure 112 of the present embodiment can be bonded within the outer edge of the cover plate 111, for example, 0.3 mm. Therefore, the display device 100 of the present disclosure can use an additional 0.8 mm, which is suitable for the narrow frame design.

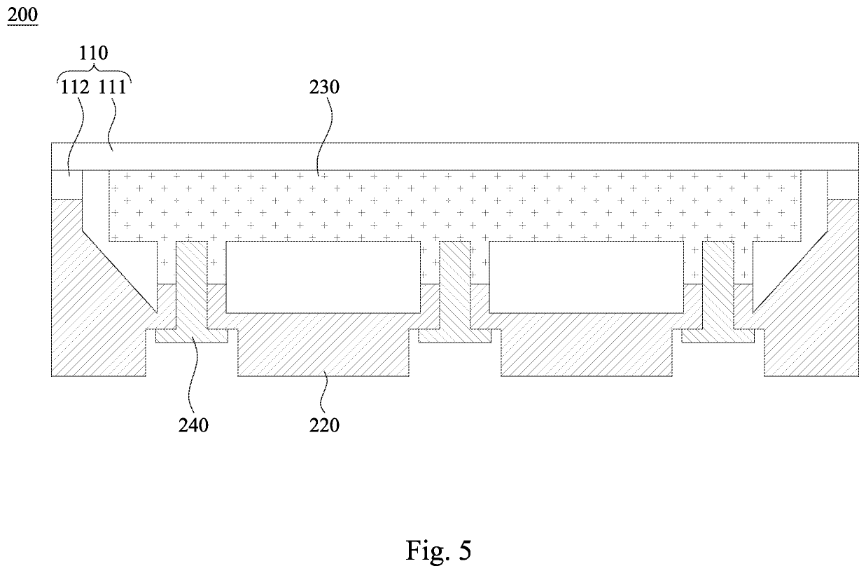

Reference is made to FIG. 5. FIG. 5 is a cross-sectional view of a display device 200 according to another embodiment of the present disclosure. As shown in FIG. 5, in the present embodiment, the display device 200 includes a protection assembly 110, an outer frame 220, and a display module 230, in which the protection assembly 110 is the same as the embodiment shown in FIG. 1, so details will not be described here. Compared with the embodiment shown in FIG. 1, the display module 230 and the outer frame 220 of the present embodiment are further fastened to each other by a fastening member 240 (such as a screw). It should be noted that since the studs of the display module 230 and the screw holes of the outer frame 220 usually have positioning deviations and tolerances, different torsion forces generated by fastening the screws may easily cause a gap difference between the cover plate 111 and the outer frame 220, which makes the periphery of the cover plate 111 not flat enough relative to the outer frame 220. However, after adopting the elastic structure 112 of the present embodiment, the gap difference between the cover plate 111 and the outer frame 220 can be significantly reduced.

In some embodiments, a surface of the outer frame 120 bonded to the second adhesive layer 112b is uneven. A gap difference between the outer frame 120 and the cover plate 111 is less than 0.3 mm. The gap difference is less than 1.2 mm after the elastic structure 112 is removed. In the following, the limited range of the aforementioned gap difference will be verified with practical examples. The samples tested in the following sets are all samples with the original gap difference (the gap difference between the cover plate 111 and the outer frame 120 that are not bonded) within 1.2 mm, and use a traditional glue dispensing method and the bonding of the elastic structure 112 respectively to test the bonding between the outer frame 120 and the cover plate 111.

Reference is made to FIG. 6. FIG. 6 is a top view of the display device 100. As shown in FIG. 6, twelve test points P1, P2, P3, P4, P5, P6, P7, P8, P9, P10, P11, P12 are selected from the periphery of the cover plate 111 to measure the gap difference between the cover plate 111 and the outer frame 120. The following table 1 is the gap test table of the display devices of several sets of examples in which the cover plates 111 and the outer frames 120 are adhered together by dispensing. It should be noted that although the same structures and materials are used in the various examples, there are still individual differences among the various examples, which are specifically shown in the obtained actual test results. In addition, the minimum gap in each set of examples is represented by 0 (mm), so as to clearly know the gap differences at the test points.

TABLE 1

| | Test point (mm) | | | | | | | | | | | |
|---|---|---|---|---|---|---|---|---|---|---|---|---|
| Set | P1 | P2 | P3 | P4 | P5 | P6 | P7 | P8 | P9 | P10 | P11 | P12 |
| 1 | 0.02 | 0.20 | 0.50 | 0.68 | 0.38 | 0.60 | 0.45 | 0.04 | 0.02 | 0 | 0 | 0 |
| 2 | 0.08 | 0.55 | 1.20 | 1.20 | 1.10 | 1.20 | 1.15 | 0.75 | 0.40 | 0.20 | 0.15 | 0 |
| 3 | 0.07 | 0.35 | 1.05 | 1.10 | 0.40 | 1.10 | 0.85 | 0.50 | 0.30 | 0.07 | 0.02 | 0 |
| 4 | 0.15 | 0.40 | 0.80 | 0.85 | 0.75 | 1.15 | 0.65 | 0.55 | 0.35 | 0 | 0.15 | 0.40 |
| 5 | 0 | 0.10 | 0.45 | 0.68 | 0.80 | 1.10 | 0.80 | 0.35 | 0.30 | 0.30 | 0.07 | 0.02 |

It can be seen from the above table 1 that the maximum value of the gap difference corresponding to the dispensing method appears in the above second set of examples (for example, the gap difference between the test point P6 and the test point P12 is 1.2 mm). In addition, the following table 2 is the gap test table of the display device 100 of several sets of examples of the present disclosure.

TABLE 2

| | Test point (mm) | | | | | | | | | | | |
|---|---|---|---|---|---|---|---|---|---|---|---|---|
| Set | P1 | P2 | P3 | P4 | P5 | P6 | P7 | P8 | P9 | P10 | P11 | P12 |
| 1 | 0.75 | 0.75 | 0.75 | 0.75 | 0.75 | 0.75 | 0.75 | 0.75 | 0.75 | 0.75 | 0.75 | 0.75 |
| 2 | 0.80 | 0.80 | 0.80 | 0.80 | 0.85 | 0.85 | 0.80 | 0.85 | 0.80 | 0.85 | 0.80 | 0.80 |
| 3 | 0.75 | 0.80 | 0.80 | 0.75 | 0.75 | 0.75 | 0.80 | 0.80 | 0.80 | 0.75 | 0.75 | 0.75 |
| 4 | 0.85 | 0.85 | 0.85 | 0.80 | 0.80 | 0.80 | 0.80 | 0.80 | 0.75 | 0.85 | 0.85 | 0.85 |
| 5 | 0.75 | 0.75 | 0.75 | 0.80 | 0.80 | 0.80 | 0.75 | 0.75 | 0.75 | 0.75 | 0.75 | 0.75 |

It can be seen from Table 2 above that the maximum value of the gap difference between the cover plate 111 and the outer frame 120 appears in the above fourth set of examples (for example, the gap difference between the test point P3 and the test point P9 is 0.1 mm). It can be seen from this that the examples in which the elastic structures 112 are used to bond the cover plates 111 and the outer frames 120 can obviously effectively reduce the gap difference.

In addition, Table 3 below is the gap test table of the display device 100 of the above-mentioned multiple examples of the present disclosure after the temperature shock test. In some embodiments, the test condition of the temperature shock test is, for example, first at −40° C. for 30 minutes and then at 80° C. for 30 minutes as a cycle, and this cycle is repeated about 400 to 900 times, but the present disclosure is not limited in this regard.

TABLE 3

| | Test point (mm) | | | | | | | | | | | |
|---|---|---|---|---|---|---|---|---|---|---|---|---|
| Set | P1 | P2 | P3 | P4 | P5 | P6 | P7 | P8 | P9 | P10 | P11 | P12 |
| 1 | 0.75 | 0.75 | 0.75 | 0.75 | 0.75 | 0.75 | 0.75 | 0.75 | 0.75 | 0.75 | 0.75 | 0.75 |
| 2 | 0.85 | 0.90 | 1.20 | 1.05 | 0.85 | 0.95 | 0.90 | 0.90 | 0.90 | 0.90 | 0.90 | 0.90 |
| 3 | 0.85 | 0.85 | 0.95 | 0.95 | 0.75 | 0.75 | 0.80 | 0.80 | 0.80 | 0.80 | 0.80 | 0.80 |
| 4 | 0.85 | 0.85 | 0.85 | 0.90 | 0.90 | 0.90 | 0.90 | 0.90 | 0.90 | 0.85 | 0.85 | 0.85 |
| 5 | 0.85 | 0.85 | 0.85 | 0.85 | 0.85 | 0.90 | 0.75 | 0.75 | 0.75 | 0.80 | 0.80 | 0.80 |

It can be seen from Table 3 above that the maximum value of the gap difference between the cover plate 111 and the outer frame 120 appears in the above second set of examples (for example, the gap difference between the test point P2 and the test point P3 is 0.3 mm). It can be seen that even after the temperature shock test, the gap difference between the cover plate 111 and the outer frame 120 using the elastic structure 112 is still smaller than the gap difference obtained by adopting the glue dispensing method.

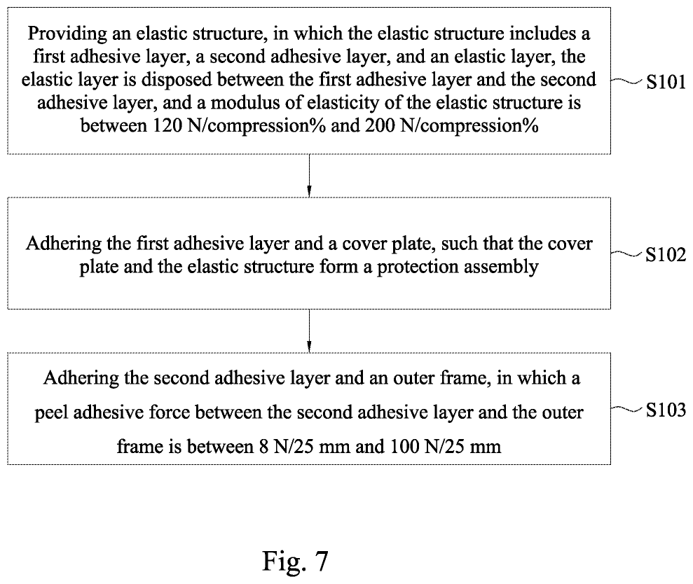

Reference is made to FIG. 7. FIG. 7 is a flowchart of a method of manufacturing a display device according to an embodiment of the present disclosure.

As shown in FIG. 7 with reference to FIG. 1 and FIG. 2 together, the method of manufacturing a display device includes steps S101 to S103.

Step S101: providing an elastic structure 112, in which the elastic structure 112 includes a first adhesive layer 112a, a second adhesive layer 112b, and an elastic layer 112c, the elastic layer 112c is disposed between the first adhesive layer 112a and the second adhesive layer 112b, and a modulus of elasticity of the elastic structure 112 is between 120 N/compression % and 200 N/compression %.

Step S102: adhering the first adhesive layer 112a and a cover plate 111, such that the cover plate 111 and the elastic structure 112 form a protection assembly 110.

Step S103: adhering the second adhesive layer 112b and an outer frame 120, in which a peel adhesive force between the second adhesive layer 112b and the outer frame 120 is between 8 N/25 mm and 100 N/25 mm.

In some embodiments, the method of manufacturing a display device further includes: performing a plasma cleaning process to the cover plate 111 before adhering the first adhesive layer 112a and the cover plate 111.

In some embodiments, the method of manufacturing a display device further includes: performing a plasma cleaning process to the outer frame 120 before adhering the second adhesive layer 112b and the outer frame 120.

As mentioned above, by cleaning the outer frame 120 and/or the cover plate 111 (for example, by a plasma cleaning process) before the elastic structure 112 is bonded to the outer frame 120 and/or the cover plate 111, the peel adhesive force can be further improved.

According to the foregoing recitations of the embodiments of the disclosure, it can be seen that in the display device of the present disclosure, the cover plate of the protection assembly is bonded to the outer frame through the elastic structure. Specifically, the elastic structure is a composite structure composed of multiple adhesive layers and an elastic layer, so the elastic structure can significantly reduce the gap difference between the cover plate and the outer frame, thereby improving the flatness. Moreover, compared with the traditional glue dispensing method, the method of manufacturing a display device of the present disclosure has the effects of process savings and yield improvement.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A display device, comprising:
a protection assembly comprising a cover plate and an elastic structure, wherein the elastic structure comprises:
a first adhesive layer adhered to the cover plate;
a second adhesive layer; and
an elastic layer disposed between the first adhesive layer and the second adhesive layer; and
an outer frame adhered to the second adhesive layer,
wherein a modulus of elasticity of the elastic structure is between 120 N/compression % and 200 N/compression %, and a peel adhesive force between the second adhesive layer and the outer frame is between 8 N/25 mm and 100 N/25 mm.

2. The display device of claim 1, wherein a viscosity of the second adhesive layer is greater than a viscosity of the first adhesive layer.

3. The display device of claim 1, wherein a thickness of the elastic structure is in a range from 0.55 mm to 1.05 mm.

4. The display device of claim 1, wherein a material of the first adhesive layer comprises a polymer.

5. The display device of claim 1, wherein a material of the elastic layer comprises polyurethane.

6. The display device of claim 1, wherein a material of the second adhesive layer comprises acrylic fiber.

7. The display device of claim 6, wherein the material of the second adhesive layer further comprises polyethylene terephthalate.

8. The display device of claim 1, wherein the elastic structure is frame-shaped.

9. The display device of claim 1, further comprising a display module, wherein the display module is disposed between the cover plate and the outer frame, and the elastic structure surrounds the display module.

10. The display device of claim 9, wherein the display module and the outer frame are fastened to each other.

11. The display device of claim 10, wherein a surface of the outer frame bonded to the second adhesive layer is uneven, a gap difference between the outer frame and the cover plate is less than 0.3 mm, and the gap difference is less than 1.2 mm after the elastic structure is removed.

12. A method of manufacturing a display device, comprising:
providing an elastic structure, wherein the elastic structure comprises a first adhesive layer, a second adhesive layer, and an elastic layer, the elastic layer is disposed between the first adhesive layer and the second adhesive layer, and a modulus of elasticity of the elastic structure is between 120 N/compression % and 200 N/compression %;
adhering the first adhesive layer and a cover plate, such that the cover plate and the elastic structure form a protection assembly; and
adhering the second adhesive layer and an outer frame, wherein a peel adhesive force between the second adhesive layer and the outer frame is between 8 N/25 mm and 100 N/25 mm.

13. The method of claim 12, wherein a viscosity of the second adhesive layer is greater than a viscosity of the first adhesive layer.

14. The method of claim 12, wherein a material of the first adhesive layer comprises a polymer.

15. The method of claim 12, wherein a material of the elastic layer comprises polyurethane.

16. The method of claim 12, wherein a material of the second adhesive layer comprises acrylic fiber.

17. The method of claim 16, wherein the material of the second adhesive layer further comprises polyethylene terephthalate.

18. The method of claim 12, further comprising:
performing a plasma cleaning process to the cover plate before adhering the first adhesive layer and the cover plate.

19. The method of claim 12, further comprising:
performing a plasma cleaning process to the outer frame before adhering the second adhesive layer and the outer frame.
